(19) United States
(12) Patent Application Publication
(10) Pub. No.: US 2024/0107564 A1
(43) Pub. Date: Mar. 28, 2024

(54) COMMUNICATION RELAY SYSTEM AND RADIO DEVICE

(71) Applicants: KABUSHIKI KAISHA TOSHIBA, Tokyo (JP); Toshiba Infrastructure Systems & Solutions Corporation, Kawasaki-shi (JP)

(72) Inventor: Toshinori DOI, Tokyo (JP)

(73) Assignees: KABUSHIKI KAISHA TOSHIBA, Tokyo (JP); Toshiba Infrastructure Systems & Solutions Corporation, Kawasaki-shi (JP)

(21) Appl. No.: 18/534,820

(22) Filed: Dec. 11, 2023

Related U.S. Application Data
(63) Continuation of application No. PCT/JP2022/023803, filed on Jun. 14, 2022.

(30) Foreign Application Priority Data
Jun. 15, 2021 (JP) 2021-099394

(51) Int. Cl. H04W 72/51; H04W 16/28; H04W 72/044

(52) U.S. Cl. CPC H04W 72/51; H04W 16/28; H04W 72/046

(57) ABSTRACT

A communication relay system of an embodiment includes a master unit capable of transmitting/receiving a signal to/from a base station of a mobile communication system, and a plurality of remote units transmitting/receiving a signal to/from the master unit and performing radio communication with a mobile station of the mobile communication system. The master unit includes a detector, a determiner, and an allocator. The detector detects that the mobile station is located at a position where wireless communication with the plurality of remote units is possible. The determiner determines to which of the plurality of remote units a communication resource for performing radio communication with the mobile station located at a position where radio communication is possible is to be allocated. The allocator allocates a communication resource to the remote unit according to the determination result of the determiner.

This application is a Continuation Application of PCT Application No. PCT/JP2022/023803, filed Jun. 14, 2022 and based upon and claiming the benefit of priority from prior Japanese Patent Applications No. 2021-099394, filed Jun. 15, 2021, the entire contents of all of which are incorporated herein by reference.

### FIELD

Embodiments described herein relate generally to a communication relay system and a radio device.

### BACKGROUND

In Japan, fifth generation mobile communication system (5G) service started in 2020. Beam forming is one of the technologies attracting attention in 5G. This is a technique for cooperatively operating a plurality of antenna elements included in one antenna and forming a beam of a radio wave in a discretionary direction. This technique is generally realized by combination with a huge number of antenna elements (Massive MIMO). This technology realizes an expansion of an area (cover area) in which radio communication is possible or an increase in cell capacity by simultaneous communication with a plurality of users.

A distributed antenna system (DAS) is known as a system for expanding a cover area of a mobile communication system. The DAS relays signals related to communication between a mobile station and a base station. The DAS includes a master unit and a plurality of remote units arranged in a distributed manner. The master unit distributes a signal from the base station to a plurality of remote units. The remote units output a downlink signal from their respective antennas. As a result, the area of the base station is expanded to the location of the remote units.

If the DAS is simply applied to the 5G system, the same signal is output from each of the remote units. That is, the beams from all the remote units are directed in the same direction (azimuth). There is room for consideration in efficiently utilizing radio resources.

### BRIEF DESCRIPTION OF THE DRAWING(S)

FIG. 1 is a system diagram showing an example of a mobile communication system including a communication relay system.

FIG. 2 is a block diagram showing an example of a master unit shown in FIG. 1.

FIG. 3 is a block diagram showing an example of a remote unit shown in FIG. 1.

FIG. 4 is a functional block diagram showing an example of the radio communicator shown in FIG. 3.

FIG. 5 is a diagram for explaining beam forming by the remote unit.

FIG. 6 is a diagram for explaining allocation of the number of streams to a mobile station UE.

FIG. 7 is a diagram for explaining beam forming by the remote unit.

FIG. 8 is a diagram for explaining a high-speed search.

FIG. 9 is a diagram for explaining a low-speed search.

FIG. 10 is a diagram for explaining a tracking search.

FIG. 11 is a diagram for explaining a tracking search in a case where the mobile station moves.

FIG. 12 is a diagram for explaining searching for a plurality of mobile stations.

FIG. 13 is a diagram for explaining searching for a plurality of mobile stations.

FIG. 14 is a diagram for explaining searching for a plurality of mobile stations.

FIG. 15 is a flowchart showing an example of a beam forming process performed by the remote unit.

FIG. 16 is a diagram showing an example of beam control according to a process procedure of FIG. 15.

FIG. 17 is a flowchart showing an example of a beam forming process performed by the master unit.

FIG. 18 is a diagram for explaining cooperative beam control according to the embodiment.

FIG. 19 is a diagram for explaining cooperative beam control according to the embodiment.

### DETAILED DESCRIPTION

The communication relay system of an embodiment includes a master unit capable of transmitting/receiving a signal to/from a base station of a mobile communication system, and a plurality of remote units transmitting/receiving a signal to/from the master unit and performing radio communication with a mobile station of the mobile communication system. The master unit includes a detector, a determiner, and an allocator. The detector detects that the mobile station is located at a position where wireless communication with the plurality of remote units is possible. The determiner determines to which of the plurality of remote units a communication resource for performing radio communication with the mobile station located at a position where radio communication is possible is to be allocated. The allocator allocates a communication resource to the remote unit according to the determination result of the determiner.

Hereinafter, a communication relay system according to an embodiment will be described with reference to the drawings.

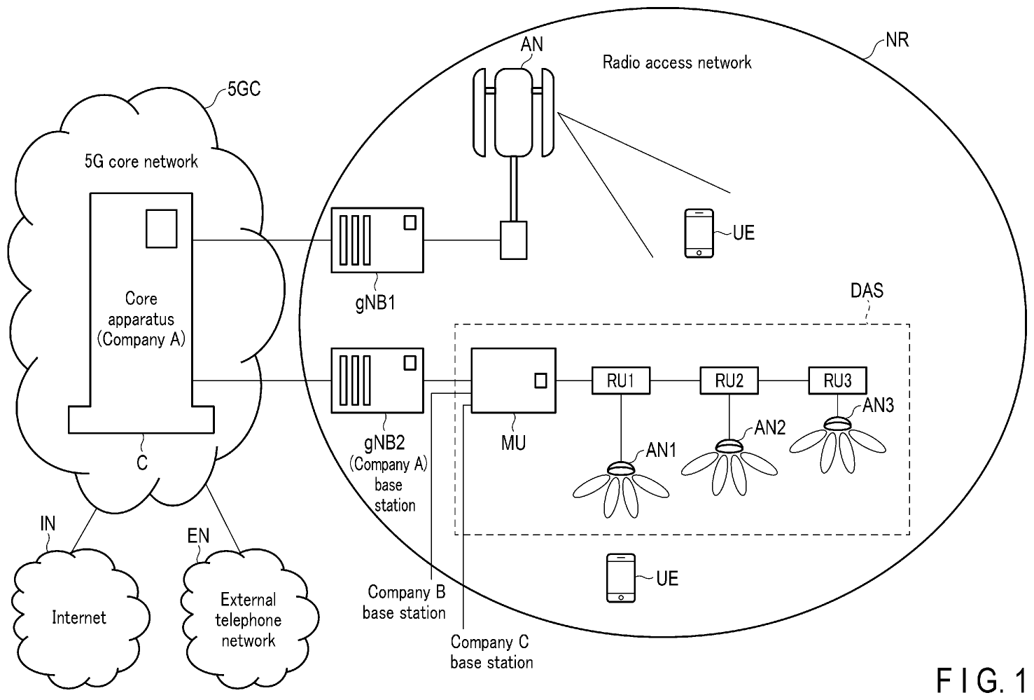

FIG. 1 is a system diagram showing an example of a mobile communication system including a communication relay system. The mobile communication system shown in FIG. 1 includes a 5th generation core network (5G core network) 5GC and a radio access network NR (New Radio). In the example shown in FIG. 1, the radio access network NR comprises a communication relay system.

The 5G core network 5GC controls the radio access network NR and exchanges various kinds of traffic with an external network (the Internet IN, an external telephone network EN, or the like). The 5G core network 5GC includes a core apparatus C as its center. The core apparatus C performs, for example, authentication/security management, session management, policy control, packet transfer, and the like.

The radio access network NR includes a plurality of base station apparatuses (for example, gNodeB (gNB)1 and gNB2 in FIG. 1). The base station apparatuses gNB1 and gNB2 are controlled by the core apparatus C, and each forms a radio communication area (a so-called cell) capable of wirelessly communicating with a mobile station (user equipment: UE).

The base station apparatus gNB1 is connected to an antenna apparatus AN provided on a roof of a building or a dedicated tower. The base station apparatus gNB1 wirelessly communicates with the mobile station UE in the cover area of the antenna apparatus AN, and connects the mobile station UE to the 5G core network 5GC through the core apparatus C.

In addition, the base station apparatus gNB1 performs beam forming by controlling phases of signals related to a large number of antenna elements of the antenna apparatus AN. This technology is related to massive MIMO and contributes to an increase in communication volume and the like.

The base station apparatus gNB2 has the same function as that of the base-station apparatus gNB1. The base station apparatus gNB2 wirelessly communicates with the mobile station UE through the DAS, so that the mobile station UE is connected to the 5G core network NW through the core apparatus C.

The DAS is an example of a communication relay system according to the present embodiment. The DAS is used in a special place to form a relatively small-scale cover area compared to that of the antenna apparatus AN (for example, an inside of a building, an underground mall, or other structures, a sparsely or densely populated area, an area in which tower construction is difficult or limited, and a site such as an event hall where the antenna apparatus AN is not permanently placed). As shown in FIG. 1, the DAS includes a master unit MU, remote units RU1 to RU3, and antennas AN1 to AN3.

In FIG. 1, the DAS is shown in the radio access network NR. However, the DAS is not always controlled by the 5G core network 5GC or the base station apparatus gNB2. The DAS can autonomously perform control such as beam forming.

The master unit MU collectively controls each portion of the DAS. The master unit MU is connected to the base station apparatus gNB2 shown in FIG. 1 (for example, the base station apparatus of a communication service provider A) by a coaxial cable (for example, 100 MHz band×4 (4×4 MIMO configuration)). Similarly, the master unit MU is connected to each of base station apparatuses gNB2 of other communication service providers B and C (not shown) by another coaxial cable. That is, the master unit MU is connected to each gNodeB of the communication service providers A, B, and C by a coaxial cable.

The master unit MU serves as a communication relay apparatus. That is, the master unit MU connects the mobile station UE to the base station apparatus gNB2 of the communication service provider to which the user of the mobile station UE subscribes via the antennas AN1 to AN3 and the remote units RU1 to RU3 corresponding thereto.

The antennas AN1 to AN3 are connected to the corresponding remote units RU1 to RU3, respectively. Each of the antennas AN1 to AN3 includes a large number of antenna elements and supports massive MIMO. In beam forming, the phases of transmission RF signals and/or reception RF signals associated with the antenna elements are individually adjusted. For example, the antenna elements are divided into four groups each including 4×4 antenna elements, and the directivity may be controlled for each group.

In this embodiment, in order to simplify the description, it is assumed that each of the antennas AN1 to AN3 can simultaneously form a maximum of four beams corresponding to the groups in arbitrary directions. Further, in order to simplify the description, it is assumed that the master unit MU can simultaneously process (relay) a maximum of four streams corresponding to the four beams.

In an actual apparatus, the number of beams is not limited to four, but may be three or less or five or more. Furthermore, the number of beams formed by each of the antennas AN1 to AN3 is not fixed but may be dynamically changed by changing the number of antenna elements to be used.

The remote units RU1 to RU3 are connected to the corresponding antennas AN1 to AN3. The remote units RU1 to RU3 are communicably connected to the master unit MU via an optical communication line. As shown in FIG. 1, the remote units RU1 to RU3 are connected to the master unit MU by a daisy chain system, for example. In addition, the remote units RU1 to RU3 may be directly connected to the master unit MU in a star topology (not shown).

In the following description, the term “remote unit RUn” may be used. The description of “remote unit RUn” is common to all of the remote units RU1 to RU3. That is, “n” can be read as any one of 1 to 3. This is for the purpose of avoiding redundancy of the description and confusion of the correspondence relationship of the configurations.

Similarly, the term “antenna ANn” may be used. The term means that the antenna is connected to the remote unit RUn, and refers to one of the antennas AN1 to AN3. That is, “n” can be read as any one of 1 to 3, and the antenna ANn is connected to the remote unit RUn.

The remote unit RUn can perform beam forming by phase adjustment on the antenna ANn. Further, the remote unit RUn can detect (search for) a direction in which the mobile station UE is located by measurement of reception signal intensity and beam forming, and can maintain communication by tracking a mobile station UE which is moving.

The beam forming will be described in detail. Regarding uplink, the remote unit RUn adjusts the phase of an RF signal captured by the antenna ANn and performs beam forming. In the embodiment, the antenna ANn is capable of simultaneously capturing reception RF signals corresponding to a maximum of four beams, and is compatible with the frequency bands of any of the aforementioned three communication service providers.

Furthermore, the remote unit RUn down-converts the reception RF signals corresponding to the respective beams, and simultaneously demodulates four reception signals respectively corresponding to the maximum of four beams. Then, the remote unit RUn serially multiplexes the demodulated reception signals, converts the electrical signals into optical signals (that is, modulates an optical carrier), and transmits the optical signals to the master unit MU via the optical communication line. A stream included in the reception signal is referred to as a UL stream signal.

Regarding downlink, the remote unit RUn detects an optical signal addressed to itself (the remote unit RUn) from among optical signals transferred from the master unit MU via the optical communication line, and converts the optical signal into an electrical signal. As a result, signals corresponding to four streams at the maximum (hereinafter referred to as DL stream signals) are simultaneously demodulated.

Then, the remote unit RUn generates a transmission RF signal obtained by modulating a carrier wave of a frequency band corresponding to the communication service provider using the DL stream signal, to radiate the transmission RF signal into a space via the antenna ANn. In the embodiment, the antenna ANn is capable of beam-forming to form a beam for each of four DL stream signals at the maximum. In addition, the antenna ANn corresponds to any frequency band of the three communication service providers described above.

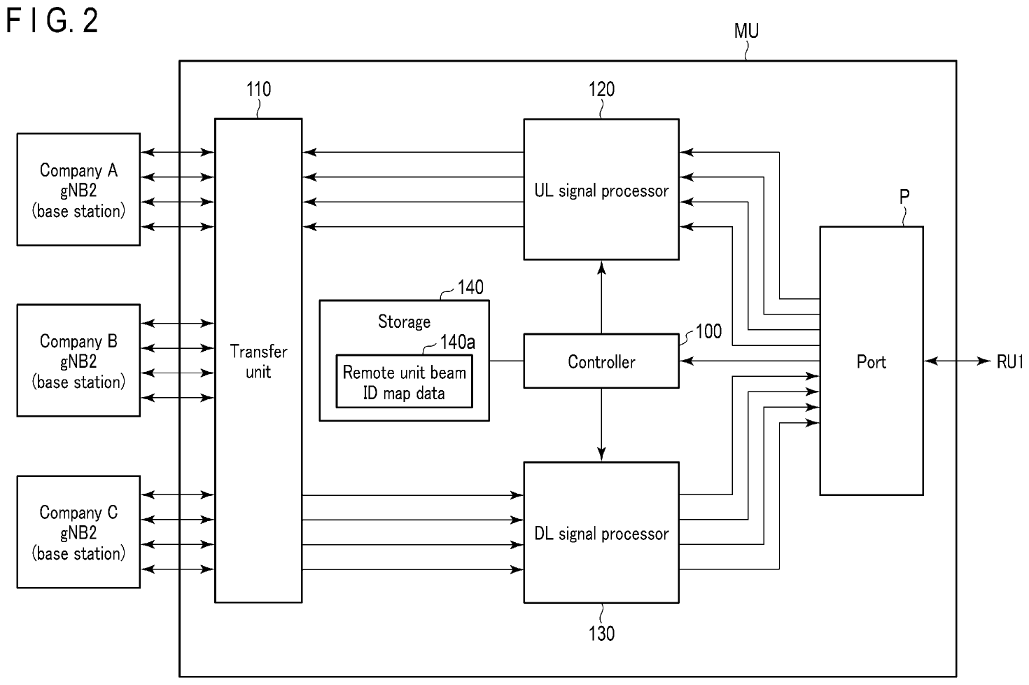

FIG. 2 is a block diagram showing an example of the master unit MU shown in FIG. 1. The master unit MU includes a port unit P, a controller 100, a transfer unit 110, an uplink (UL) signal processor 120, a downlink (DL) signal processor 130, and a storage unit 140.

The port unit P is connected to the remote unit RU1 via the optical communication line. The band of the optical communication line is, for example, 25 Gbps. The port unit P is also connected to the UL signal processor 120 and the DL signal processor 130.

Optical signals transmitted and received between the master unit MU and the remote units RU1, RU2 and RU3 are multiplexed and flow via the optical communication line. Therefore, the port unit P is substantially connected to the remote units RU2 and RU3. The master unit MU can communicate with any of the remote units RU1 to RU3 by an optical signal (transmit and receive an optical signal).

The port unit P demultiplexes the multiplexed optical signal arriving from the remote unit RU1 in the uplink into a plurality of optical signals, performs optical/electrical conversion on each optical signal, and demodulates the electrical signals. The electrical signals are reception signals (that is, UL stream signals) corresponding to each beam in the remote units RU1 to RU3. The reception signals are output in parallel to the UL signal processor 120.

The port unit P functions as an information detector that detects information transmitted from the remote units RU1 to RU3 from each reception signal. For example, the port unit P monitors a reception signal and detects a communication start request (PRACH) from the mobile station UE, a stream ID allocated to each reception signal (UL stream signal), and the like.

In addition, the port unit P detects identification information of a transmission source (one of the remote units RU1 to RU3) from the reception signal. Further, the port unit P detects the identification information of the mobile station UE located in the cover area, the position information (beam ID) indicating the position of the mobile station UE in the cover area, and the service provider ID indicating the communication service provider to which the user of the mobile station UE subscribes from the reception signal for each of the remote units RU1 to RU3. These detection results are reported to the controller 100.

On the other hand, a DL stream signal arriving in the downlink from the DL signal processor 130 is input to the port unit P. Then, the port unit P adds identification information of the remote units RU1 to RU3 which are destinations to the input DL stream signals and converts the DL stream signals into optical signals (modulation of optical carriers). The port unit P multiplexes these optical signals and transmits the multiplexed signals to the remote units RU1 to RU3 via the optical communication line.

The transfer unit 110 is connected to the base stations gNB2 of the communication service providers A, B, and C via communication lines (coaxial cables). The transfer unit 110 communicates with the base stations gNB2 of the respective providers via the communication lines. That is, the transfer unit 110 transfers UL signals input from the UL signal processor 120 in the uplink to the base stations gNB2 of the corresponding communication service providers. In addition, the transfer unit 110 receives DL stream signals transferred in the downlink from the base stations gNB2 of the respective communication service providers via the communication lines, and outputs the DL stream signals to the DL signal processor 130.

Under the control of the controller 100, the UL signal processor 120 adds the reception signals of the respective beams input from the port unit P for each communication service provider (signal addition processing). Then, the signal obtained for each communication service provider is output as the UL signal to the transfer unit 110 for each communication service provider.

Under the control of the controller 100, the DL signal processor 130 multiplexes the DL stream signals of each communication service provider input from the transfer unit 110 and outputs the multiplexed signal to the port unit P (multiplexing processing).

The controller 100 functions as an example of a detector, a determiner, an allocator, and a resource detector. The controller 100 collectively controls each portion of the master unit MU. The controller 100 includes a memory and a processor (not shown). The processor realizes various functions by an arithmetic process based on a program and data loaded from the storage 140 onto a work memory.

For example, the controller 100 relays communication between the mobile station UE and the base stations gNB2 via the remote units RU1 to RU3. In addition, the controller 100 allocates streams to the remote units RU1 to RU3 and performs cooperative beam forming control based on a detection result reported from the port unit P, a DL stream signal transferred from the base stations gNB2, and the like.

The controller 100 stores remote unit information and mobile station information in the memory, and manages these pieces of information while updating them. The remote unit information includes capabilities (such as the number of streams that can be handled) of the remote units RU1 to RU3, the number of streams allocated at the present time, and the like. The mobile station information includes current position information of the mobile station UE and the like. In the stream allocation control, the controller 100 refers to the remote unit information and the mobile station information, and appropriately allocates streams to the remote units RU1 to RU3 based on a comprehensive determination.

In the cooperative beam forming control, the controller 100 manages usage statuses (availabilities) of radio resources for the respective remote units RU1 to RU3. The controller 100 controls the remote units RU1 to RU3 to cooperatively direct the beams of the remote units RU1 to RU3 to the mobile station UE located in a place where the cover areas of the remote units RU1 to RU3 overlap in accordance with the usage statuses of the radio resources.

For example, in a case where the mobile station UE is located in a place where the cover area of the remote unit RU1 and the cover area of the remote unit RU2 overlap each other, and both the remote units RU1 and RU2 have enough radio resources, the controller 100 performs beam forming so that both the remote units RU1 and RU2 transmit and receive radio band signals to and from the mobile station UE.

On the other hand, for example, in a case where the mobile station UE is located in a place where the cover area of the remote unit RU1 and the cover area of the remote unit RU2 overlap each other, and the remote unit RU1 does not have enough radio resources, beam forming is performed so that only the remote unit RU2 transmits and receives a radio band signal to and from the mobile station UE.

The storage 140 stores a program, data, a remote unit beam ID map data 140a, and the like, for causing the controller 100 to function. The program and data may be installed in the storage 140 at the time of manufacturing. Alternatively, the program and data may be installed or updated through an external interface (not shown) at the time of initial setting. Alternatively, the program and data may be installed or updated from a server on the 5G core network 5GC such as the core apparatus C.

The remote unit beam ID map data 140a is used in cooperative beam forming control. The remote unit beam ID map data 140a is a data table in which beam ID map data 240a respectively held in the remote units RU1 to RU3 under the control of the master unit MU are collected. Details of the beam ID map data 240a will be described later.

The remote unit beam ID map data 140a includes a beam direction for each beam that can be formed by each of the remote units RU1 to RU3 and a beam ID associated with each beam direction. The beam direction is represented by, for example, coordinates. Identification information (for example, a superposition flag) for identifying an overlap area OA is assigned to a beam direction of a portion where cover areas of the remote units RU1 to RU3 overlap (a portion where beams overlap between the remote units).

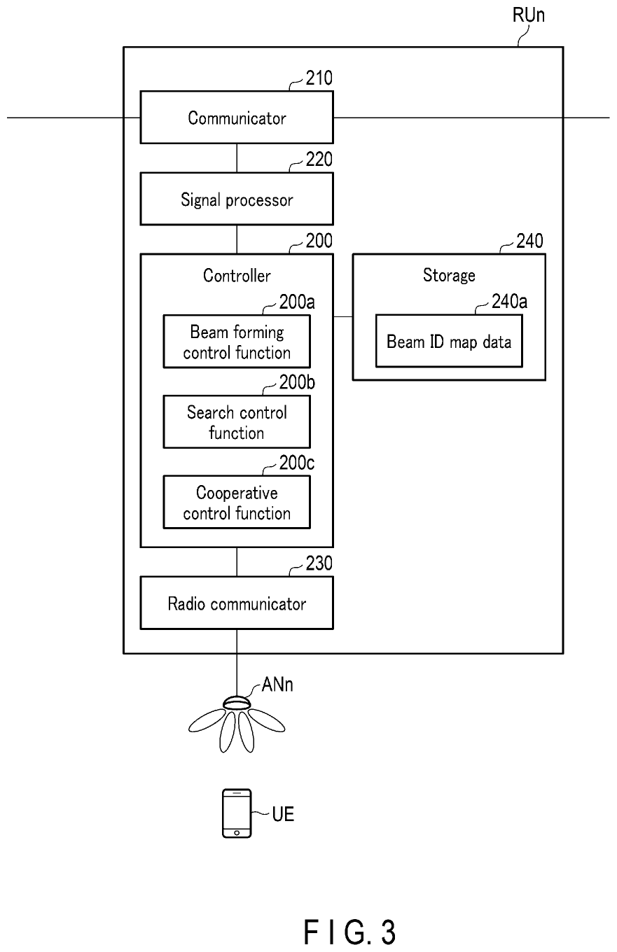

FIG. 3 is a block diagram showing an example of the remote unit RUn (RU1 to RU3) shown in FIG. 1. The remote unit RUn includes a controller 200, a communicator 210, a signal processor 220, a radio communicator 230 connected to the antenna ANn, and a storage 240.

The communicator 210 transmits and receives an optical signal to and from the master unit MU via the optical communication line. The communicator 210 includes at least two ports each accommodating an optical communication line. The communicator 210 amplifies an optical signal from one port and outputs the amplified optical signal to the other port. Thus, a relay function of an optical communication relay is realized. The communicator 210 further has a branching/multiplexing function, a modulating/demodulating function, and the like. The branching/multiplexing function is a function of branching/multiplexing an optical signal of an optical communication line. The modulating/demodulating function is a function of a modulator/demodulator for mutually converting an optical signal and an electrical signal.

The modulator/demodulator may have an optical-to-electrical conversion function and an electrical-to-optical conversion function. The optical-to-electrical conversion function is a function of converting an optical signal from an optical communication line into an electrical signal to obtain a communication signal (DL stream signal). The electrical-to-optical conversion function is a function of converting a communication signal (UL stream signal) from the signal processor 220 into an optical signal and transmitting the optical signal to an optical communication line.

The signal processor 220 communicates with the base station gNB2 using a predetermined communication protocol. The signal processor 220 demodulates and decodes the downlink signal that has reached the communicator 210, and detects a DL stream signal addressed to the remote unit RUn based on the identification information for identifying the destination. The detection result is reported to the controller 200.

The signal processor 220 generates a UL stream signal by modulating a carrier with an uplink signal addressed to the base station gNB2 and provided from the controller 200. The UL stream signal is output to the communicator 210. Identification information of a transmission source (any one of the remote units RU1 to RU3) is added to the UL stream signal by the signal processor 220 or the controller 200.

The radio communicator 230 performs radio communication with the mobile station UE via the antenna ANn in a radio access scheme compliant with 5G. The mobile station UE can perform radio communication with the base station gNB2 via the antenna ANn in the same access scheme as that in the case of accessing the base station gNB1 via the antenna AN (shown in FIG. 1).

The radio communicator 230 controls phases of signals (transmission RF signals and/or reception RF signals) in a large number of antenna elements on the antenna ANn in accordance with instructions from the controller 200. Thus, beam forming by massive MIMO is performed.

The radio communicator 230 measures the reception signal intensity (for example, RSSI) from the mobile station UE and reports to the controller 200 the measurement result in association with identification information of the mobile station UE. Since the frequency bands of the communication service providers are different from one another, the reception signal intensity is detected for each frequency band (that is, for each communication service provider). The detection result is reported to the controller 200.

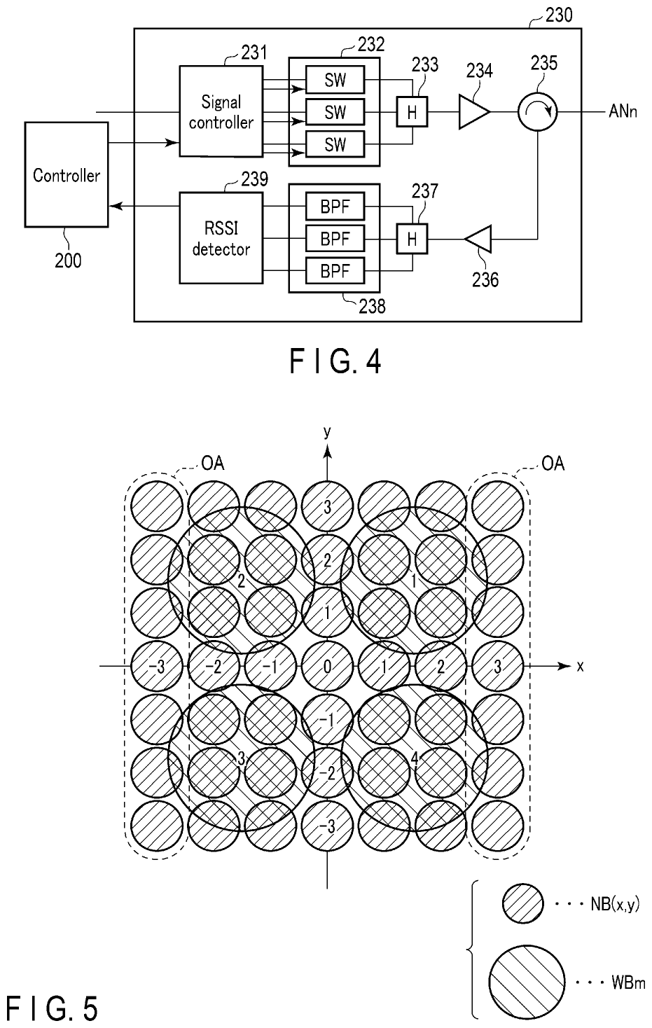

FIG. 4 is a functional block diagram showing an example of the radio communicator 230 shown in FIG. 3. The radio communicator 230 detects the reception signal intensity for each communication service provider with the configuration shown in FIG. 4, for example. In FIG. 4, configurations related to transmission/reception and modulation/demodulation of a radio band signal are omitted.

The radio communicator 230 includes a signal controller 231, an output switch (SW) 232, a downlink hybrid circuit 233, a transmission amplifier 234, a circulator 235, a reception amplifier 236, an uplink hybrid circuit 237, a bandpass filter 238, and an RSSI detector 239.

The signal controller 231 separates a radio band signal of the downlink for each frequency band of each communication service provider, and outputs the signal to the output switch 232. The output switch 232 includes output switches for the respective communication service providers. The signal controller 231 individually controls ON/OFF of the output switches. Thus, the downlink signal is selectively output for the frequency band of each communication service provider.

The downlink hybrid circuit 233 combines the signals from the output switch 232 into one radio band signal and outputs the signal to the transmission amplifier 234.

The transmission amplifier 234 amplifies the radio band signal from the downlink hybrid circuit 233 and outputs the amplified signal to the antenna ANn via the circulator 235. The antenna ANn radiates a radio band signal into space, and the radio band signal is captured by the mobile station UE.

A radio band signal of the uplink from the mobile station UE is captured by the antenna ANn and is output to the reception amplifier 236 via the circulator 235. The reception amplifier 236 amplifies the radio band signal and outputs the signal to the uplink hybrid circuit 237.

The uplink hybrid circuit 237 distributes the signal input from the reception amplifier 236 to as many communication service providers as there are and outputs the distributed signals to the bandpass filter 238.

The bandpass filter 238 includes filters for the frequency bands of the respective communication service providers. Each filter outputs a signal in the frequency band of the corresponding communication service provider.

The RSSI detector 239 detects the reception intensity (RSSI) for the frequency band of each communication service provider and reports the detection result to the controller 200. Upon receiving the report, the controller 200 specifies the communication service provider that outputs the signal and sends a report to the signal controller 231. Based on this report, the signal controller 231 performs ON/OFF control of the output switch 232 so that only the radio band signal of the designated communication service provider is output.

Referring back to FIG. 3, the description of the configuration of the remote unit RUn will be continued.

The controller 200 functions as an example of a service provider detector and a transmission end controller. The controller 200 collectively controls each portion of the remote unit RUn. The controller 200 includes a memory and a processor (not shown). The processor realizes various functions by an arithmetic process based on a program and data loaded from the storage 240 to a work memory.

The controller 200 has a communication control function. The communication control function connects the mobile station UE wirelessly connected to the remote unit RUn to the 5G core network 5GC via the master unit MU and the base station gNB2. In addition, the controller 200 includes a beam forming control function 200a, a search control function 200b, a cooperative control function 200c, and a processing function for integrating and executing these functions.

The communication control function detects a communication service provider of a downlink signal arriving from the base station gNB2 via the communicator 210 and the signal processor 220. The communication control function controls the radio communicator 230 to transmit the downlink signal in the frequency band of the detected communication service provider.

The communication control function detects the communication service provider of the uplink signal received by the radio communicator 230 from the mobile station UE. The communication control function controls the signal processor 220 and the communicator 210 so as to transmit an uplink signal from the mobile station UE to the base station gNB2 of the detected communication service provider.

The beam forming control function 200a performs beam forming with a predetermined algorithm in accordance with the number of streams allocated to the mobile station UE, and the like. The beam forming control function 200a controls the massive MIMO using the radio communicator 230. The beam forming control function 200a controls the orientation direction, the range, and the beam width of the beam based on the beam ID map data 240a.

FIG. 5 is a diagram for explaining beam forming by the remote unit. For example, as shown in FIG. 5, the beam forming control function 200a controls the orientation direction, the range, and the beam width of the beam. The beam forming control function 200a selectively forms a narrow beam NB or a wide beam WB in an arbitrary direction or range.

In FIG. 5, the formation positions (directions) of beams formed by the beam forming control function 200a are shown. In FIG. 5, the cover area of the remote unit RUn is defined on the x-y plane. The beam forming control function 200a may form a narrow beam NB (x, y) toward preset coordinates (x, y). The beam forming control function 200a can form a wide beam WBm (m is any one of 1 to 4) toward each quadrant on the x-y plane.

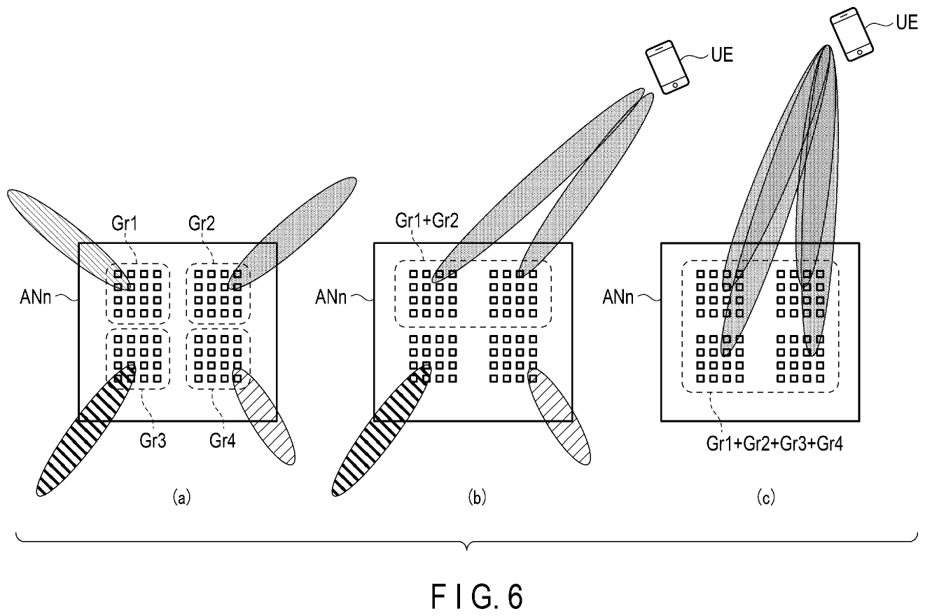

FIG. 6 is a diagram for explaining allocation of the number of streams to a mobile station UE. For example, as shown in FIG. 6 (a), the beam forming control function 200a divides the antenna elements of the antenna ANn into four groups Gr1 to Gr4 corresponding to four streams. Then, the beam forming control function 200a controls the beam direction of each of the groups Gr1 to Gr4 to an arbitrary direction.

In a case where one mobile station UE is located in the cover area of the antenna ANn and two streams are allocated to the mobile station UE, the beam forming control function 200a performs beam forming as shown in FIG. 6 (b), for example. That is, the beam forming control function 200a directs the stream by the group Gr1 and the stream by the group Gr2 to the mobile station UE.

In a case where one mobile station UE is located in the cover area of the antenna ANn and four streams are allocated to the mobile station UE, the beam forming control function 200a performs beam forming as shown in FIG. 6 (c), for example. That is, the beam forming control function 200a directs the streams of the respective groups Gr1 to Gr4 to the mobile station UE.

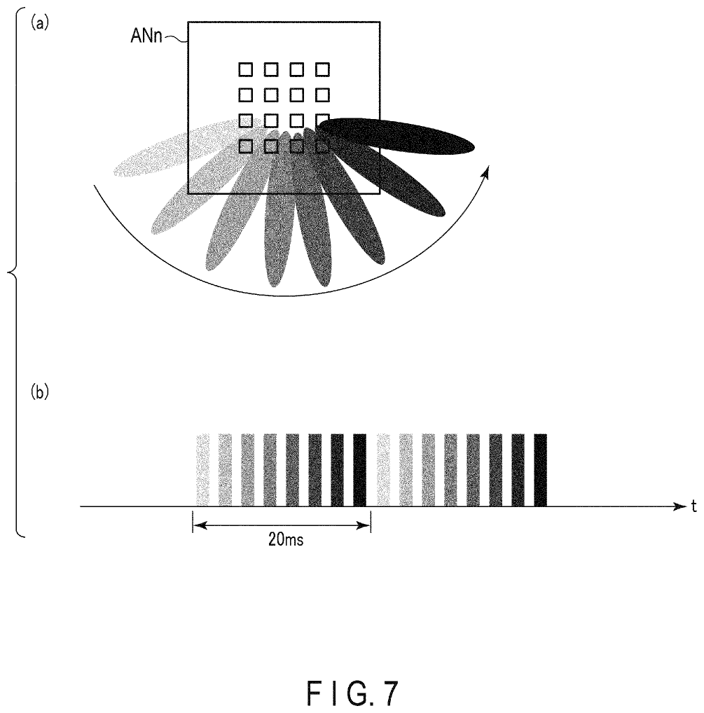

FIG. 7 is a diagram for explaining beam forming by the remote unit. The search controller 200b controls the radio communicator 230 to search for the mobile station UE and estimate (detect) the position (direction and range) in which the mobile station UE is located. The search control function 200b controls the massive MIMO using the radio communicator 230 to repeatedly perform sweeping every 20 ms in the direction in which the beam is directed within an arbitrary range as shown in FIG. 7 (a), for example. During that time, the search control function 200b monitors the reception signal intensity sequentially detected by the radio communicator 230, thereby detecting a direction and a range in which the mobile station UE is located.

FIG. 7 (b) shows the timing of each of the beams shown in FIG. 7 (a). The direction of the beam in FIG. 7 (a) and the timing of the corresponding beam in FIG. 7 (b) are represented by the same shading.

The controller 200 can switch among three modes of a high-speed search, a low-speed search, and a tracking search to search for the mobile station UE using the search control function 200b.

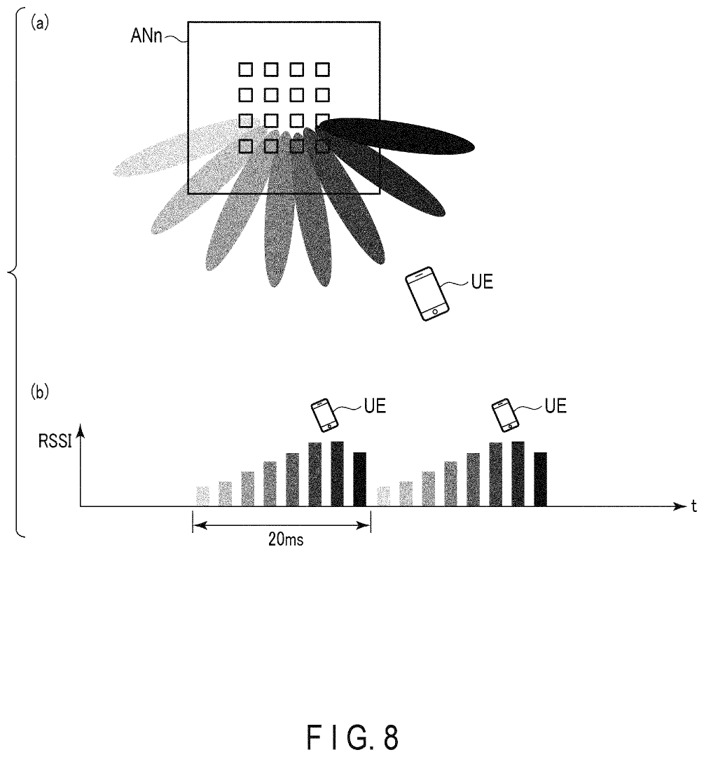

FIG. 8 is a diagram for explaining a high-speed search. In the high-speed search, the controller 200 repeatedly performs sweeping every 20 ms (FIG. 8 (b)) with a beam in which the variable range in the orientation direction (for example, in the horizontal direction) is set to about 120° (FIG. 8 (a)). During that time, the radio communicator 230 sequentially detects the reception signal intensity. The controller 200 monitors the reception signal intensity to detect the identification information, the direction, and the range of the mobile station UE.

The high-speed search is independently performed for each of the groups Gr1 to Gr4 of the antenna elements. The search azimuth of each of the groups Gr1 to Gr4 may be arbitrarily set at the time of initial setting, for example. Alternatively, the search control functions 200b may set/update the search azimuth of each of the groups Gr1 to Gr4 on the basis of statistical data or learning data of the position information of the mobile station UE cumulatively stored in the storage 240.

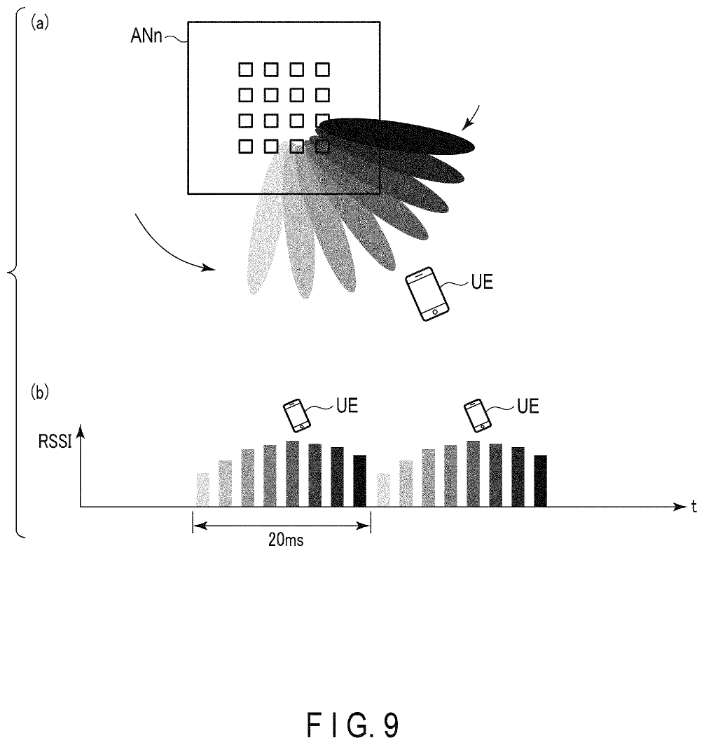

FIG. 9 is a diagram for explaining a low-speed search. In the low-speed search, the controller 200 repeatedly performs sweeping every 20 ms (FIG. 9 (b)) with a beam in which the variable range in the orientation direction (for example, in the horizontal direction) is set to about 90° (FIG. 9 (a)). During that time, the radio communicator 230 sequentially detects the reception signal intensity. The controller 200 monitors the reception signal intensity at the same frequency as in the high-speed search to more accurately detect the identification information, the direction, and the range of the mobile station UE.

The low-speed search is independently performed for each of the groups Gr1 to Gr4 of the antenna elements. The search azimuth of each of the groups Gr1 to Gr4 is centered on the direction in which the mobile station UE is detected in the high-speed search. The range of the search azimuth may be arbitrarily set, for example, at the time of initial setting. Alternatively, the search control functions 200b may set/update the range of the search azimuth on the basis of statistical data or learning data of the position information of the mobile station UE cumulatively stored in the storage 240.

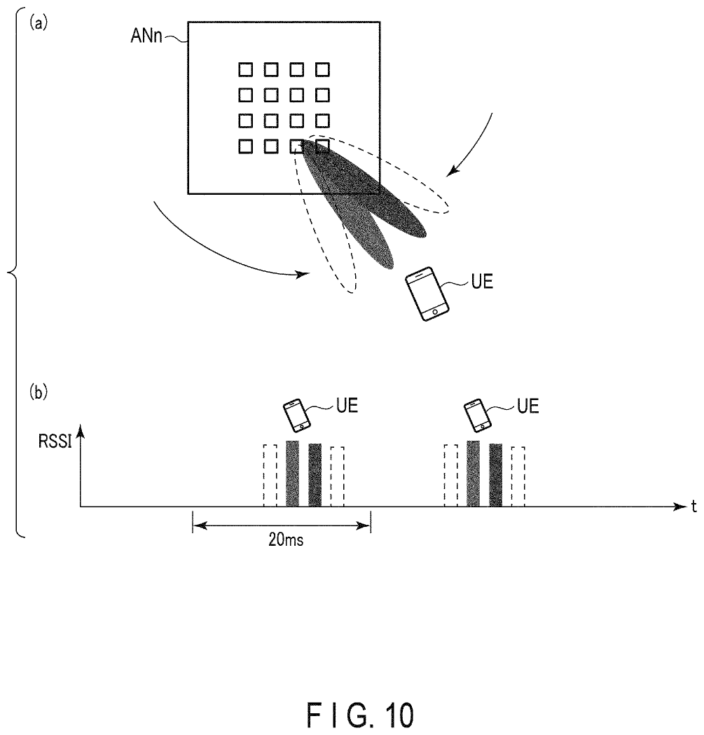

FIG. 10 is a diagram for explaining a tracking search. In the tracking search, the controller 200 repeatedly performs sweeping every 20 ms (FIG. 10 (b)) with a beam in which the variable range in the orientation direction (for example, in the horizontal direction) is set to a trackable range (about 45° in the example of FIG. 10 (a)). During that time, the radio communicator 230 sequentially detects the reception signal intensity. The controller 200 monitors the reception signal intensity to more accurately detect the identification information, the direction, and the range of the mobile station UE.

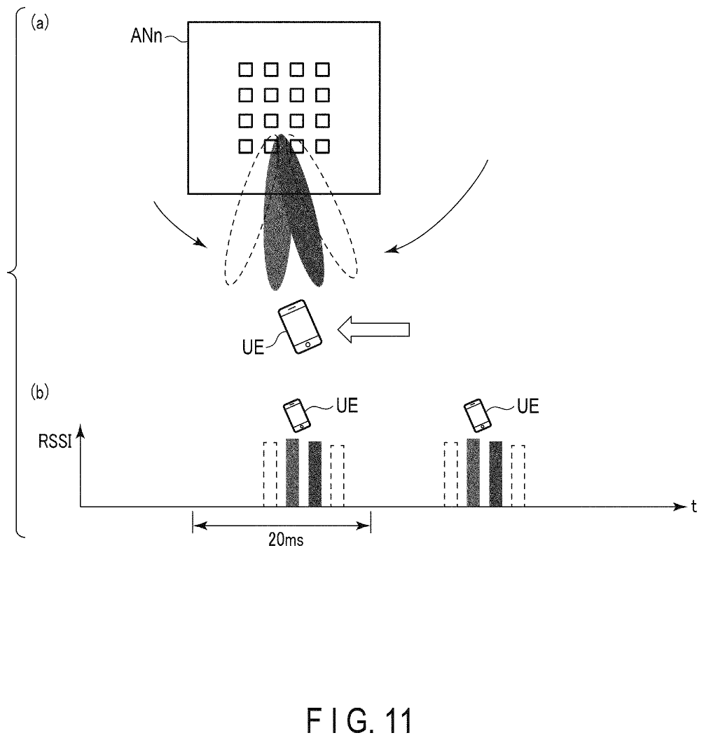

FIG. 11 is a diagram for explaining a tracking search in a case where the mobile station moves. When the mobile station UE moves as shown in FIG. 11 (a), for example, the reception signal intensity of each beam and the magnitude relation between the reception signal intensities in the respective directions change as shown in FIG. 11 (b). The controller 200 estimates the moving direction of the mobile station UE based on this change, and changes the orientation direction of the beam so as to track the mobile station UE.

The controller 200 may change the range in which the mobile station UE can be tracked based on the data learned about the movement of the mobile station UE. Alternatively, the controller 200 may change the range in which the mobile station UE can be tracked based on the distance between the remote unit RUn and the mobile station UE estimated from the reception signal intensity. If the reception signal intensity is relatively high, the distance between the remote unit RUn and the mobile station UE can be determined to be short; therefore, the controller 200 may widen the range in which the mobile station UE can be tracked. On the other hand, if the reception signal intensity is relatively low, the distance between the remote unit RUn and the mobile station UE can be determined to be long; therefore, the controller 200 may narrow the range in which the mobile station UE can be tracked.

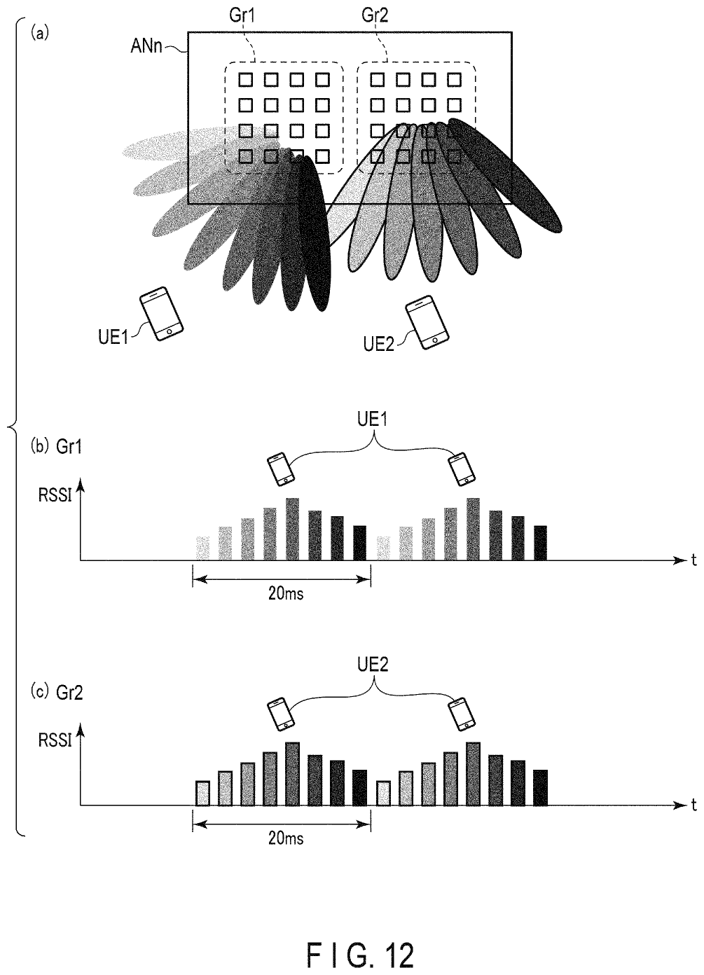

FIGS. 12 to 14 are diagrams for explaining searching for a plurality of mobile stations. As shown in FIG. 12 (a), a case is assumed in which a plurality of mobile stations UE1 and UE2 are located in substantially the same azimuth with respect to the antenna ANn. In this case, the search control function 200b sets a search range of, for example, each of the two groups Gr1 and Gr2, and individually searches for the mobile stations UE1 and UE2.

FIG. 12 (b) shows a change in the reception signal intensity of the mobile station UE1 detected by the group Gr1 in the case of FIG. 12 (a), and FIG. 12 (c) shows a change in the reception signal intensity of the mobile station UE2 detected by the group Gr2.

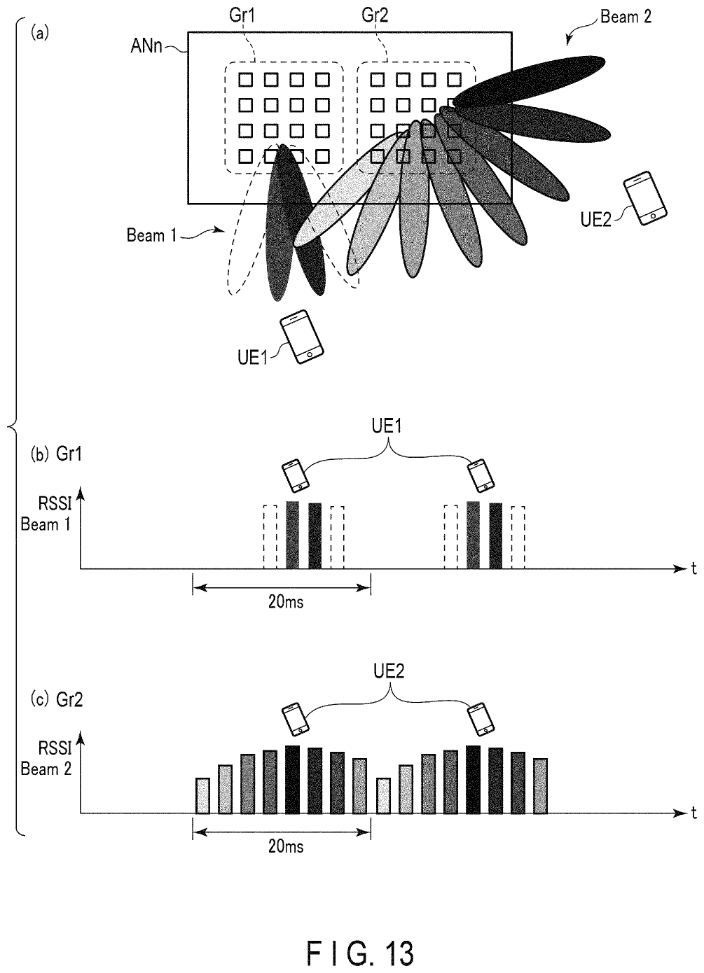

The groups Gr1 and Gr2 are controlled independently of each other by the controller 200. For example, as shown in FIG. 13 (a), in parallel with tracking the mobile station UE1 by performing the low-speed search with the group Gr1, the high-speed search for the mobile station UE2 can be performed by the group Gr2.

FIG. 13 (b) shows a change in the reception signal intensity of the mobile station UE1 detected by the group Gr1 in the case of FIG. 13 (a), and FIG. 13 (c) shows a change in the reception signal intensity of the mobile station UE2 detected by the group Gr2.

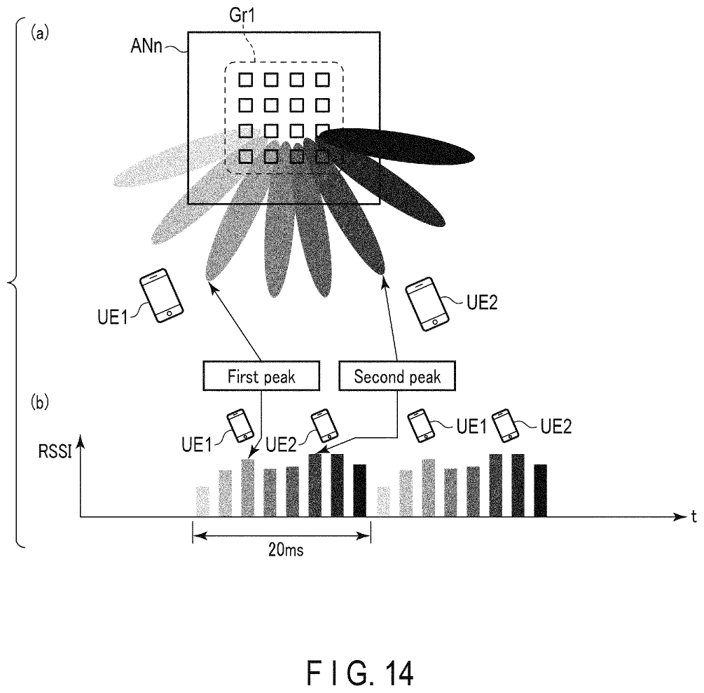

It is also possible to search for a plurality of mobile stations by one group. For example, as shown in FIG. 14 (a), the two mobile stations UE1 and UE2 can be searched by the group Gr1. In this case, as shown in FIG. 14 (b), two peaks appear in the reception signal intensity. The controller 200 can detect the number of mobile stations and their directions by detecting the peaks in the reception signal intensity.

Referring back again to FIG. 3, the description will be continued.

The cooperative control function 200c is a control function that performs beam forming in cooperation with another remote unit RUm having an overlapping cover area based on an instruction from the master unit MU. This control function includes a function of controlling the frequency band transmitted from the radio communicator 230 based on the reception signal intensity for each communication service provider reported from the radio communicator 230.

The storage 240 stores a program, data, a beam ID map data 240a, and the like, for causing the controller 200 to function. The program and data may be installed in the storage 240 at the time of manufacturing. Alternatively, the program and data may be installed or updated through an external interface (not shown) at the time of initial setting. Alternatively, the program and data may be installed or updated from a server on the 5G core network 5GC such as the core apparatus C.

The beam ID map data 240a is generated by dividing the cover area of the remote unit RUn for each beam orientation direction (for example, as shown in FIG. 5) and assigning a beam ID to each division. That is, the cover area is defined and divided on the x-y plane, the beam ID of the narrow beam directed to each division is assigned NB (x, y), and the beam ID of the wide beam directed to each quadrant is assigned WBm. The beam ID map data 240a is generated by presetting the orientation direction of the beam based on such a rule.

The remote units RU1 to RU3 are arranged so that their cover areas partially overlap one another. The overlapped portion is referred to as an overlap area OA. In the overlap area OA, a plurality of remote units can direct beams to spatially the same position. Each of the remote units RU1 to RU3 sets the beam ID described above.

The remote unit beam ID map data 140a stored in the storage 140 of the master unit MU is data that is generated by collecting the beam ID map data 240a of the remote units RU1 to RU3 that are under the control of the master unit MU. In the remote unit beam ID map data 140a, identification information (for example, a superposition flag) indicating a beam direction in the overlap area OA is assigned to a beam ID in the overlap area OA.

Next, the operation of the above configuration will be described. The process procedure in the embodiment includes a remote unit beam forming process by the remote unit RUn and a master unit beam forming process by the master unit MU.

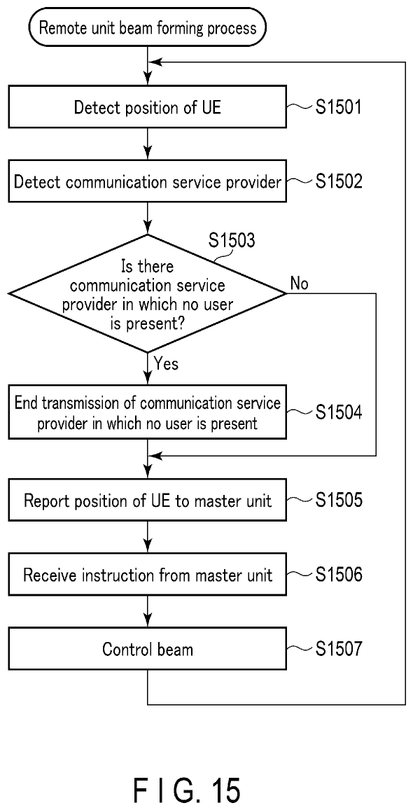

FIG. 15 is a flowchart showing an example of a beam forming process performed by the remote unit. The process procedure shown in FIG. 15 is repeatedly executed by the remote unit RUn. The controller 200 of the remote unit RUn may execute several process procedures including the process procedure shown in FIG. 15 simultaneously in parallel.

In step S1501 of FIG. 15, the controller 200 controls the radio communicator 230 using the search control function 200b to estimate (detect) the position of the mobile station UE. In addition, the controller 200 detects the communication service provider to which the user of the mobile station UE subscribes from the reception signal of the mobile station UE.

The search control function 200b controls the radio communicator 230 to detect the reception signal intensity while changing the beam direction. Upon detection of the mobile station UE based on the reception signal intensity, the search control function 200b refers to the beam ID map data 240a and specifies the beam ID corresponding to the detected direction and range as the position of the mobile station UE.

In step S1502, the controller 200 detects the communication service provider of the mobile station UE located in the cover area of the remote unit RUn.

The cooperative control function 200c controls the radio communicator 230 to detect the reception signal intensity for each of the communication service providers, and determines that the communication service provider having a detection result equal to or greater than a threshold value has the user (mobile station UE). On the other hand, it is determined that there is no user in the communication service provider having a detection result of the frequency band less than the threshold value.

The communication service provider may be detected based on the mobile station UE detected in step S1501. That is, the communication service provider to which the mobile station UE subscribes may be specified based on the reception signal from the detected mobile station UE.

In step S1503, the controller 200 uses the cooperative control function 200c to determine whether or not there is a communication service provider in which no user is present in the cover area of the remote unit RUn based on the detection result of step S1502.

If there is a communication service provider in which no user is present, the process procedure proceeds to step S1504. If there is no communication service provider in which a user is not present (i.e., if a user is present in every communication service provider), the process procedure proceeds to step S1505.

In step S1504, the controller 200 controls the radio communicator 230 using the cooperative control function 200c so that only the downlink signal of the communication service provider in which a user is present is transmitted.

The cooperative control function 200c reports the communication service provider in which a user is present to the signal controller 231 in the radio communicator 230. The signal controller 231 that has received the report turns on the switch corresponding to the communication service provider of the output switch 232 and outputs only the radio signal in the frequency band of the reported communication service provider to the downlink hybrid circuit 233. Therefore, the radio signal in the frequency band of the communication service provider which did not receive a report from the controller 200 (the communication service provider in which no user is present) is stopped. That is, the controller 200 stops the radio signal of the communication service provider in the frequency band which is not detected by the cooperative control function 200c.

In step S1505, by using the cooperative control function 200c, the controller 200 notifies (reports) the master unit MU of the position (beam ID) of the mobile station UE detected in step S1501 and the identification information (service provider ID) of the communication service provider of the service to which the mobile station UE subscribes.

In step S1506, the controller 200 receives an instruction related to beam forming from the master unit MU by using the cooperative control function 200c. This instruction can be performed based on the information reported to the master unit MU in step S1505. This instruction includes the beam ID and the service provider ID.

In step S1507, the controller 200 controls the radio communicator 230 according to the instruction (the beam ID or the service provider ID) received in step S1506 using the beam forming control function 200a. The radio communicator 230 performs beam forming in the direction, the range, and the frequency band based on control of the beam forming control function 200a. Then, the process procedure proceeds to step S1501 again.

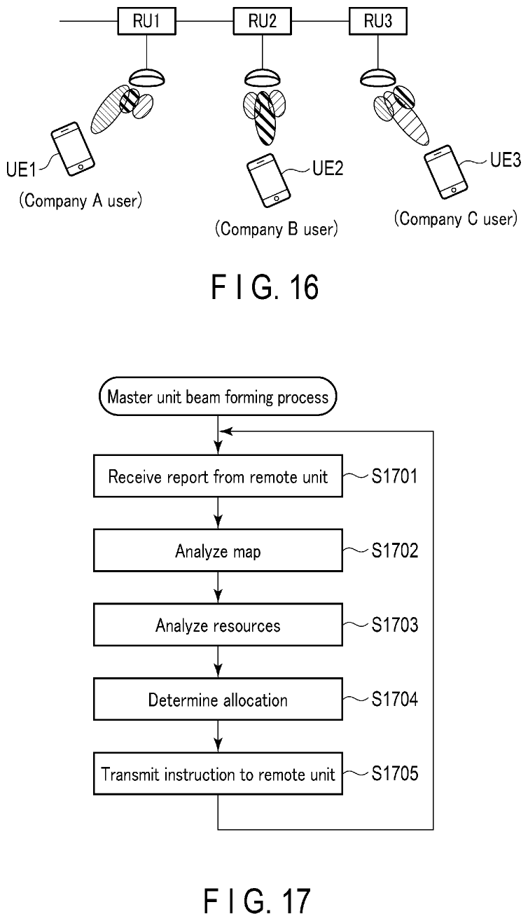

FIG. 16 is a diagram showing an example of beam control according to a process procedure of FIG. 15. In FIG. 16, it is assumed that the mobile station UE1 is located in the cover area of the remote unit RU1, the mobile station UE2 is located in the cover area of the remote unit RU2, and the mobile station UE3 is located in the cover area of the remote unit RU3. Here, the communication service providers of the mobile stations UE1 to UE3 are different from one other. In this case, each of the remote units RU1 to RU3 transmits only a radio signal in the frequency band of the communication service provider in which a user is present.

By such control, the power consumption of each of the remote units RU1 to RU3 can be saved. For the mobile station UE, since the influence of an unnecessary radio signal is suppressed, improvement in communication quality can be expected. In particular, in a position where the cover areas of the remote units RU1 and RU3 overlap, or in a case where the remote units are close to each other, a further improvement in communication quality can be expected as compared with the conventional art.

Next, the master unit beam forming process will be described.

FIG. 17 is a flowchart showing an example of a process procedure of a master unit beam forming process. The process procedure shown in FIG. 17 is repeatedly executed by the master unit MU. The controller 100 of the master unit MU may execute several process procedures including the process procedure shown in FIG. 17 simultaneously in parallel.

The process procedure shown in FIG. 17 is repeatedly executed until the operation of the master unit MU is stopped or a stop command is issued from the core apparatus C or the like to the master unit MU.

In step S1701 of FIG. 17, the controller 100 receives a notification (report) of step S1505 from the remote unit RUn. That is, the position (beam ID) of the mobile station UE in the cover area of the remote unit RUn and the identification information (service provider ID) of the communication service provider are reported to the controller 100.

In step S1702, the controller 100 analyzes whether or not the position (beam ID) of the mobile station UE received in step S1701 is included in the cover area of another remote unit based on the remote unit beam ID map data 140a. That is, the controller 100 determines whether or not the position of the mobile station UE based on the beam ID is a position overlapping with the cover area of another remote unit (overlap area OA). For example, this determination can be made based on whether or not a superposition flag is assigned to the beam ID.

In step S1703, if the mobile station UE is located in the overlap area OA, the controller 100 analyzes whether or not there is sufficient availability of the radio resources (for example, the number of available radio resources). The controller 100 analyzes the availability of the radio resources of the communication service provider reported in step S1701 for each of the remote unit RUn and the other remote units.

The radio resource is, for example, a resource block in orthogonal frequency division multiplexing (OFDM) communication. In addition, the number of beams that can be formed by the remote unit RUn, antenna elements for forming beams, and the like may be used as the radio resources. These radio resources are examples. Radio resources may be understood more broadly as communication resources. Communication resource include, for example, not only a radio resource but also a resource related to communication using an optical communication line with the master unit MU. In other words, “communication resource” is a term including a scope understood by a person skilled in the art in the field of communications.

If there are enough radio resources, in step S1704, the controller 100 generates an instruction to the remote unit RUn to direct a beam to the mobile station UE present in the overlap area OA and to allocate the radio resource.

If there are not enough radio resources, in step S1704, the controller 100 generates an instruction to a remote unit having enough radio resources to direct the beam to the mobile station UE present in the overlap area OA and to allocate the radio resource. That is, this instruction includes that at least either the remote unit RUn or another remote unit having enough radio resources directs a beam to the overlap area OA and allocates radio resources.

In a case where a plurality of remote units respectively communicate with the mobile stations UE, the respective remote units may be caused to transmit different streams in the downlink under the control of the controller 100. In this way, an improvement in the transmission rate can be expected. Alternatively, the same stream may be transmitted to each remote unit under the control of the controller 100. Thus, it is possible to increase the combined power in the mobile station UE and to expect an improvement in communication stability.

In step S1705, the controller 100 transmits the instruction generated in step S1704 to the corresponding remote unit. This instruction includes at least a beam ID indicating a direction of a beam and identification information of a communication service provider (service provider ID) indicating a frequency band.

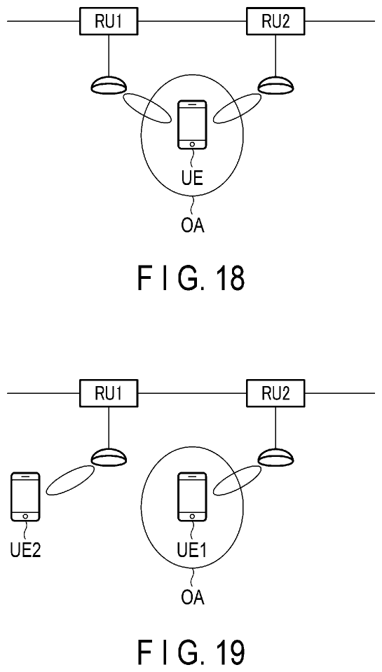

FIGS. 18 and 19 are diagrams for explaining cooperative beam control according to the embodiment. FIG. 18 shows a master unit beam forming process in a case where the mobile station UE is located in the overlap area OA in which the cover areas of the remote units RU1 and RU2 overlap. If there are enough radio resources, each of the remote units RU1 and RU2 forms a beam toward the mobile station UE in the overlap area OA based on an instruction from the master unit MU and performs communication.

FIG. 19 shows a master unit beam forming process in a case where the mobile station UE is located in the overlap area OA in which the cover areas of the remote units RU1 and RU2 overlap each other and there are not enough radio resources. If there are not enough radio resources, only one of the remote units RU1 and RU2 (the remote unit RU2 in FIG. 19) forms a beam toward the mobile station UE in the overlap area OA based on the instruction of the master unit MU and performs communication.

In the communication relay system according to the embodiment, the communication service provider of the mobile station UE located in the cover area is detected for each of the remote units RU1 to RU3. Based on the result, the radio signal of the frequency band of the communication service provider whose cover area does not include the mobile station UE is not transmitted.

With such a configuration, the remote unit RUn does not transmit an unnecessary radio signal. Therefore, the power consumption of the entire system can be suppressed. Furthermore, transmission of a radio signal that may affect the cover area of a mobile station UE of another communication service provider or another remote unit is suppressed, and improvement in communication quality can be expected.

In addition, according to the communication relay system having the above-described configuration, if the mobile station UE is located in the overlap area OA in which the cover areas of the plurality of remote units overlap one another, it is possible to perform resource allocation for cooperative communication among the plurality of remote units under the control of the master unit MU. For this reason, improvement in communication quality of the cover area and improvement in communication capacity can be expected.

The present invention is not limited to the embodiment described above and can be embodied in practice by modifying the structural elements without departing from the gist of the invention. In addition, various inventions can be made by suitably combining the structural elements disclosed in connection with the above embodiments. Furthermore, for example, a configuration may be considered in which some structural elements of all the structural elements described in the embodiment are deleted. Furthermore, structural elements of different embodiments may be suitably combined.

For example, in the embodiment described above, the case where the remote unit RUn determines not to transmit a radio signal to a frequency band of a communication service provider in which there is no user has been described as an example. Alternatively, this determination may be performed by the controller 100 of the master unit MU. That is, the controller of the master unit MU may function as the service provider detector and the transmission end controller.

It is needless to say that various modifications can be made without departing from the scope of the present invention.

What is claimed is:

1. A communication relay system comprising:
a master unit capable of transmitting and receiving a signal to and from a base station of a mobile communication system; and
a plurality of remote units configured to transmit and receive the signal to and from the master unit and wirelessly communicate with a mobile station of the mobile communication system,
the master unit including:
a detector configured to detect that the mobile station is located at a position where radio communication with the plurality of remote units is possible;
a determiner configured to determine to which of the plurality of remote units communication resources for performing radio communication with the mobile station located at the position where the radio communication is possible are to be allocated; and
an allocator configured to allocate the communication resources to the remote units in accordance with a determination result of the determiner.

2. The communication relay system according to claim 1, wherein
the master unit further includes a resource detector configured to detect availabilities of the respective communication resources of the plurality of remote units, and
the determiner is configured to determine to which of the plurality of remote units communication resources for performing radio communication with the mobile station located at the position where the radio communication is possible are to be allocated, in accordance with a detection result of the resource detector.

3. The communication relay system according to claim 2, wherein
the determiner is configured to determine to which one of the plurality of remote units a communication resource for performing radio communication with the mobile station located at the position where the radio communication is possible is to be allocated, in accordance with a detection result of the resource detector.

4. A communication relay system, comprising:
a master unit capable of transmitting and receiving a signal to and from a base station of a mobile communication system; and
a plurality of remote units configured to transmit and receive the signal to and from the master unit and wirelessly communicate with a mobile station of the mobile communication system,
each of the plurality of remote units including:
a service provider detector configured to detect a communication service provider to which the mobile station subscribes; and
a transmission end controller configured to stop a radio signal in a frequency band of a communication service provider not detected by the service provider detector.

5. A radio device configured to transmit and receive a signal to and from a master unit capable of transmitting and receiving the signal to and from a base station of a mobile communication system and to perform radio communication with a mobile station of the mobile communication system, the radio device comprising:
a service provider detector configured to detect a communication service provider to which the mobile station subscribes; and
a transmission end controller configured to stop a radio signal in a frequency band of a communication service provider not detected by the service provider detector.
